(19) United States
(12) Patent Application Publication
(10) Pub. No.: US 2022/0252422 A1
(43) Pub. Date: Aug. 11, 2022

(54) METHOD, APPARATUS, AND SYSTEM FOR CONSTRUCTING A HIGH-RESOLUTION MAP FOR GEOSPATIAL BIG DATA PROCESSING

(71) Applicant: HERE Global B.V., Eindhoven (NL)

(72) Inventor: Zhenhua ZHANG, Chicago, IL (US)

(21) Appl. No.: 17/171,755

(22) Filed: Feb. 9, 2021

(51) Int. Cl. G01C 21/00; G06T 3/40

(52) U.S. Cl. CPC G01C 21/3867; G01C 21/3837; G06T 3/4007

(57) ABSTRACT

An approach is disclosed for generating a high-resolution map for geospatial big data processing. The approach involves, e.g., receiving a request to convert a line-based map representation of a geographic area to a point-based map representation of the geographic area at a target resolution, wherein the line-based map representation represents one or more map features in the geographic area as a plurality of links respectively formed by at least two shape locations. The approach also involves generating one or more interpolated shape locations between at least two consecutive shape locations based on the target resolution, wherein the interpolated shape locations respectively specify an interpolated point location between two consecutive shape locations and a link heading associated with the interpolated point location. The approach further involves generating the point-based map representation to include the one or more interpolated shape locations. The approach further providing the point-based map representation as an output.

### BACKGROUND

Location-based service providers (e.g., mapping and navigation providers) are continually challenged to provide compelling services and applications. One area of development relates to processing large sets of geographic data and/or geospatial big data in connection with providing users up to date roadwork analysis, traffic flow information, and/or digital maps/updates. However, processing large data sets (e.g., map matching 50 million observations per day) can consume significant computing nodes, require substantial processing time, and/or cause service providers to incur considerable costs (e.g., related to cloud computing resources). Moreover, in the coming years, these problems are only likely to increase as sensor data from normal consumer vehicles reaches to billions, which will require additional optimization and advanced frameworks. Accordingly, service providers face significant technical challenges to process this ever-growing sensor data quickly and accurately while minimizing costs.

### SOME EXAMPLE EMBODIMENTS

Therefore, there is a need for performing geospatial big data processing quickly and accurately while minimizing costs.

According to one embodiment, a method comprises receiving a request to convert a line-based map representation of a geographic area to a point-based map representation of the geographic area at a target resolution, wherein the line-based map representation of the geographic area represents one or more map features in the geographic area as a plurality of links respectively formed by at least two shape locations. The method also comprises generating one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location. The method further comprises generating the point-based map representation to include the one or more interpolated shape locations. The method further comprises providing the point-based map representation as an output.

According to another embodiment, an apparatus comprises at least one processor, and at least one memory including computer program code for one or more computer programs, the at least one memory and the computer program code configured to, with the at least one processor, cause, at least in part, the apparatus to receive a request to convert a line-based map representation of a geographic area to a point-based map representation of the geographic area at a target resolution, wherein the line-based map representation of the geographic area represents one or more map features in the geographic area as a plurality of links respectively formed by at least two shape locations. The apparatus is also caused to generate one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location. The apparatus is further caused to generate the point-based map representation to include the one or more interpolated shape locations. The apparatus is further caused to provide the point-based map representation as an output.

According to another embodiment, a non-transitory computer-readable storage medium having stored thereon one or more program instructions which, when executed by one or more processors, cause, at least in part, an apparatus to receive a request to convert a line-based map representation of a geographic area to a point-based map representation of the geographic area at a target resolution, wherein the line-based map representation of the geographic area represents one or more map features in the geographic as a plurality of links respectively formed by at least two shape locations. The apparatus is also caused to generate one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location. The apparatus is further caused to generate the point-based map representation to include the one or more interpolated shape locations. The apparatus is further caused to process geospatial big data using the point-based map representation to provide roadwork analysis, traffic flow information, geographic map updates, or a combination thereof as an output.

According to another embodiment, an apparatus comprises means for receiving a request to convert a line-based map representation of a geographic area to a point-based map representation of the geographic area at a target resolution, wherein the line-based map representation of the geographic area represents one or more map features in the geographic as a plurality of links respectively formed by at least two shape locations. The apparatus also comprises means for generating one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location. The apparatus further comprises means for generating the point-based map representation to include the one or more interpolated shape locations. The apparatus further comprises means for providing the point-based map representation as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating a high-resolution map for geospatial big data processing, according to example embodiment(s);

FIGS. 2A and 2B are diagrams of an example minimum partition size for a high-resolution map and a traditional line-based map, respectively, according to example embodiment(s);

FIG. 3 is an example framework for geographic big data processing using a high-resolution map, according to example embodiment(s);

FIG. 4 is a diagram of the components of a mapping platform capable of generating a high-resolution map for geospatial big data processing, according to example embodiment(s);

FIG. 5 is a flowchart of a process for generating a high-resolution map for geospatial big data processing, according to example embodiment(s);

FIGS. 6A through 6C are diagrams of example user interfaces capable of generating a high-resolution map for geospatial big data processing, according to example embodiment(s);

FIG. 7 is a diagram of a geographic database, according to example embodiment(s);

FIG. 8 is a diagram of hardware that can be used to implement example embodiment(s);

FIG. 9 is a diagram of a chip set that can be used to implement example embodiment(s); and

FIG. 10 is a diagram of a mobile terminal (e.g., handset or vehicle or part thereof) that can be used to implement example embodiment(s).

### DESCRIPTION OF SOME EMBODIMENTS

Examples of a method, apparatus, and computer program for generating a high-resolution map for geospatial big data processing are disclosed. In the following description, for the purposes of explanation, numerous specific details are set forth to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form to avoid unnecessarily obscuring the embodiments of the invention.

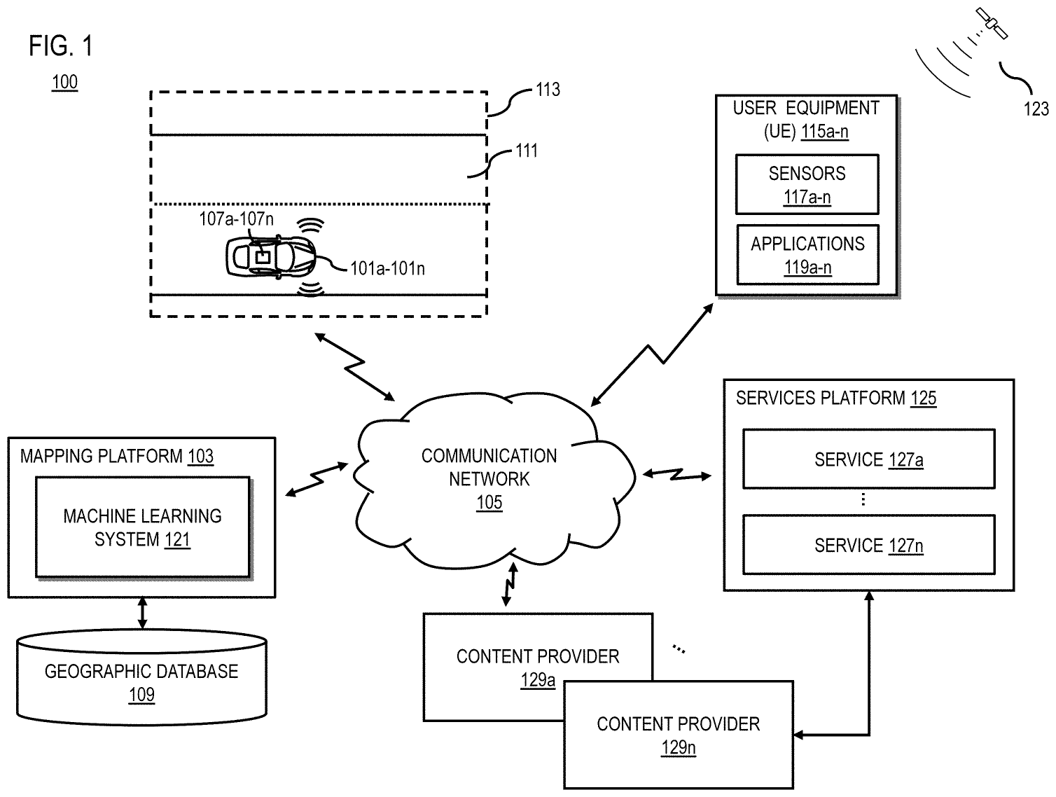

FIG. 1 is a diagram of a system 100 capable of generating a high-resolution map for geospatial big data processing, according to example embodiment(s). As described above, location-based service providers (e.g., mapping and navigation providers) are continually challenged to provide compelling services and applications. One area of development relates to processing geographic data and/or geospatial big data in connection with providing users (e.g., consumers, municipalities, city planners, etc.) up to date and/or accurate roadwork analysis, traffic flow information, and/or digital maps/updates.

At present, huge quantities of data are continuously being generated across a broad range of domains, including banking, marketing, health, telecommunications, homeland security, computer networks, e-commerce, scientific observations, simulations, etc. These data sets are an example of data that comprises “big data.” Further, “geospatial big data” refers to a specific type of big data that contains location information. In applications related to roadwork, traffic signs, traffic flow patterns, etc., geographic data processing is a crucial step. Specifically, the processing needs to match the heading and interpolate the nearest shape locations of a map link. By way of example, “links” can be defined as the road segment between two designated start and end locations. In one instance, geospatial big data processing can be achieved through intensive computation which can involve a vehicle location (e.g., a global positioning system (GPS) location, latitude, longitude, etc.), a link type (e.g., road type, functional classification (FC), etc.), and other connectivity features (e.g., roadwork detection features).

Efficiently processing big data associated with vehicle locations often requires a huge amount of computing nodes and processing time. For example, a service provider may have over 50 million observations to be map-matched per day: the processing time can be over an hour with a considerable cost in terms of cloud computing and/or cloud computing services. Moreover, in the coming years, the sensor data available from standard consumer vehicles (as opposed to purposefully equipped sensor-based vehicles) can amount up to billions and will likely require additional optimization and advanced frameworks for processing. Accordingly, service providers face significant technical challenges to process this ever-growing sensor data quickly and accurately while minimizing costs.

To address these technical problems, the system 100 of FIG. 1 introduces a capability to generate a high-resolution map for geospatial big data processing, according to example embodiment(s). In one embodiment, the system 100 can convert a traditional line-based map into a point-based high-resolution map, which has a high resolution between shape points. By way of example, a “shape point” can represent a point along a link between two nodes (e.g., used to alter a shape of the link without defining new nodes). In one instance, the data size of the new high-resolution map preserves not only the traditional map features but also sufficient point-based features for geographic big data processing.

In one embodiment, the system 100 can interpolate locations between the shape locations of the base map in connection with generating the high-resolution map. In one instance, the system 100 can interpolate the locations online or offline based on an application resolution requirement. By way of example, if an application (e.g., a navigation application) requires a map resolution of 3 meters (m) (e.g., the approximate width of a road lane and sufficient for most transportation applications), then the system 100 can interpolate the locations with a precision within 3 m. In one embodiment, the system 100 can calculate the number of partitions (or divisions) and interpolate each link segments formed by two nearby shape locations based on the required resolution (e.g., 3 m). The system 100 can interpolate, for example, the shape locations in an even and linear manner such that each interpolated segment has the same length and heading. As a result, the system 100 can calculate the partition size significantly smaller for a high-resolution map compared to the partition size sufficient for a traditional line-based map, which can enable the system 100 to process geographic big data faster since each sensor data point in a partition has much less link/point candidates compared to the traditional line-based map. Moreover, the system 100 time saving can be relatively significant when the system 100 is processing millions of partitions.

In one embodiment, the system 100 of FIG. 1 includes one or more vehicles 101a-101n (also collectively or individually referred to as vehicles 101 or a vehicle 101, respectively) (e.g., standard vehicles, autonomous vehicles, highly assisted driving (HAD) vehicles, semi-autonomous vehicles, etc.) having connectivity to a mapping platform 103 via the communication network 105 and including or equipped with one or more vehicle sensors 107a-107n (also collectively referred to as vehicle sensors 107) (e.g., camera sensors, GPS sensors, light detection and ranging (LiDAR) sensors, etc.). In one instance, the system 100 can collect geospatial big data (e.g., stored in or accessible via the geographic database 109) for each vehicle 101 on or along a link or road 111 of a given area (e.g., represented by the digital map 113) by processing probe and/or sensor data (e.g., GPS data) generated and/or transmitted by the vehicle sensors 107 (e.g., GPS sensors). The probe data may be reported, for example, as probe points, which are individual data records collected at a point in time that records telemetry data for that point in time. A probe point can include attributes such as: (1) probe ID, (2) longitude, (3) latitude, (4) heading, (5) speed, and (6) time.

In one embodiment, the system 100 also includes one or more user equipment (UE) 115a-115n (also collectively or individually referred to as UEs 115 or a UE 115, respectively) (e.g., a mobile device, a smartphone, a terminal, etc.) having connectivity to the mapping platform 103 via the communication network 105. In one instance, the UEs 115 can be associated with a user, a vehicle 101, or a combination thereof. In one instance, the UEs 115 include one or more device sensors 117 (also collectively referred to as device sensors 117) (e.g., camera sensors, GPS sensors, LiDAR sensors, etc.).

In one embodiment, the system 100 can construct a base map (e.g., a line-based digital map) based on probe or sensor data collected or received from the vehicles 101, the UEs 115, or a combination thereof to reveal a link and its shape location in a digital format as shown in the table below:

| Symbol name | Description |
|---|---|
| Link ID (t) | The unique ID for links (e.g., 1439747160). Links are |
| | defined as the road segment between two designated |
| | start and end locations. |
| Link Speed (v) | The referenced speed value for links in the map. The |
| | speed value is updated every 2-3 months. |
| Link Start | Latitude and longitude of start node based on the |
| Location (p) | standard U.S. Department of Defense definition of a |
| | global reference system for geospatial information and |
| | the reference for the GPS (WG584) (e.g., 48.55393 and |
| | 12.01813) and symbolled as plat and plon, respectively. |
| Link End | Latitude and longitude of end node based on WG584 |
| Location (q) | (e.g., 48.55393 and 12.01813) and symbolled as qlat |
| | and qlon, respectively. |
| Link Upstream | The heading of the start location of the link, measured |
| Heading (u) | as the clockwise degree between the traffic sign and |
| | due north. |
| Link | The heading of the end location of the link, measured |
| Downstream | as the clockwise degree between the traffic sign and |
| Heading (w) | due north. |
| Link Shape | A set of shape locations for the links excluding start |
| Location ([sᵢ]) | and end locations: in [sᵢ]. i is the sequence number for |
| | the shape locations. The number is equal to 1 if the |
| | shape location is closest to the start node of the link |
| | and it increases as the shape location is farther away |
| | from the start node. |

In one instance, alternatively or in addition to the collecting or receiving of data from the vehicles 101, the UEs 115, or a combination thereof, the system 100 can access or retrieve an existing base map stored in or accessible via the geographic database 109 rather than creating the base map from the probe and/or sensor data.

In one instance, the distance between two nearby shape locations can be hundreds of meters. Traditionally, the system 100 would process the sensor data (e.g., from vehicle sensors 107, device sensors 117, or a combination thereof), including map-matching, route building, etc. as follows:
sensor data matched with the shape locations within a distance threshold;
extract the shape locations within a distance threshold;
extract the link with the shortest point-to-line distance;
interpolate the map-matched location on the line formed by the “ith” and “ith+1” shape locations on that link.

In comparison, with respect to the high-resolution map, the processing of the sensor data (e.g., via the vehicles 101, the UEs 115, or a combination thereof) by the system 100 can be simplified, for example, as a location and heading approximation. In one instance, the system 100 can then determine through the matched location useful map-matched links and driving direction information.

In one embodiment, the system 100 can interpolate locations between the shape locations of the base map to generate the high-resolution map. For example, if a desired resolution of the high-resolution map is 3 meters, the system 100 can generate the high-resolution map with a precision within 3 meters. By way of example, 3 meters is approximately the width of a road lane and, therefore, such precision or resolution is often used for most transportation applications (e.g., a navigation or guidance application). In one instance, the UEs 115 can include one or more applications 119a-119n (also collectively referred to as applications 119) (e.g., navigation applications, mapping applications, etc.).

In one instance, based on the desired resolution (e.g., 3 m), the system 100 can calculate the number of partitions and interpolate each link segments formed by two nearby shape locations. In one instance, the system 100 can interpolate the locations in a linear and even manner so that each resulting interpolated segment has the same length and heading. In one instance, for each interpolated location, the system 100 can assign a sequence ID as shown below. For example, as the maximum number of shape locations in a link is not likely to exceed 1000, the system 100 can start the new sequence from i+0.001 to i+0.001*N which can be sufficient for the system 100 to determine the sequence of the interpolated locations in the segment.

| ith shape | | | | | | | (i + 1)th shape |
|---|---|---|---|---|---|---|---|
| location | Interpolated location | | | | | | location |
| sᵢ | s_{i+0.0001} | s_{i+0.0002} | s_{i+0.0003} | s_{i+0.0004} | s_{i+0.0005} | s_{i+0.0006} | sᵢ₊₁ |

In one instance, each link segment formed by two nearby shape locations by the system 100 has a unique partition number and resolution. For example, the maximum number of partitions could be as large as 1500 in a major metropolitan area (e.g., Munich, Germany). It should be apparent to one knowledgeable in the field that to extract the interpolated locations of each link segment, it is not wise to loop by each segment because it will likely consume a lot of computing resources. In contrast, the system 100 can instead, in one embodiment, loop by the number of partitions in Algorithm 1 (e.g., using the machine learning system 121):

```
Input:
  all links in an area: [ t ];
  all shape locations in an area: [ [sᵢ]ₜ ];
  all link segments formed by two consecutive shape locations in an area:
  [ [sᵢ, sᵢ₊ᵢ]ₜ ];
  number of partitions of each link segment: N(sᵢ);
  resolution of each link segment: r(sᵢ);
Output:
  interpolate locations of all links: IS;
Set MaxInteration as the max number of partitions in each link segment
[ [sᵢ, sᵢ₊₁]ₜ ]
While interation ≤ MaxInteration
  Calculate the interpolated locations in each link segment:
  ${s}_{i + iteration \times 0.001} = {s}_{i} + \frac{( {s}_{i + 1} - {s}_{i} )}{N ( {s}_{i} )} \times interation ; if interation > N ( {s}_{i} )$
  IS = bind( IS, [s_{i+iteration×0.001}]ₜ) ;
End
```

In one embodiment, the system 100 can determine the respective shape headings. The system 100 can compute, for example, the heading of each shape locations using the interpolated shapes IS. In one instance, the system 100 can determine the link direction as either “From the reference node,” “Towards the reference node,” or “Both.” If the system 100 determines that the new sequence is equal to 0, then the system 100 can determine, for example, that the corresponding shape location is the reference node of that link. Whereas, if the system 100 determines that the new sequence is equal to 999, then the system 100 can determine, for example, that the corresponding shape location is the non-reference node of that link.

In one instance, the system 100 can assume that all links' directions are “Both” and duplicate the example shape tables shown below: one to compute the heading from the reference node and the other to compute the heading towards the reference node.
For each shape location in the “From the reference node” table, the system 100 can pair its next consecutive shape locations as the matched shape to compute the headings.
For each shape location in the “Towards the reference node” table, the system 100 can pair its previous consecutive shape location as the matched shape to compute the headings.

Heading derivation from reference node

| | | Matched | Heading of |
|---|---|---|---|
| Link ID | Shape | Shape | shape |
| t₁ | s₀ | s_{0.001} | h₁ (s₀) |
| | s_{0.001} | s_{0.002} | h₁ (s_{0.001}) |
| | s_{0.002} | s₁ | h₁ (s_{0.002}) |
| | s₁ | . . . | h₁ (s₁) |
| | . . . | . . . | . . . |
| | s₉₉₉ | No match | No match |
| t₂ | s₀ | . . . | h₂ (s₀) |
| | . . . | . . . | . . . |

Heading derivation towards reference node

| | | Matched | Heading of |
|---|---|---|---|
| Link ID | Shape | Shape | shape |
| t₁ | s₉₉₉ | s_{40.002} | h₁ (s₉₉₉) |
| | s_{40.002} | s_{40.001} | h₁ (s_{40.002}) |
| | s_{40.001} | s₄₀ | h₁ (s_{40.001}) |
| | s₄₀ | . . . | h₁ (s₄₀) |
| | . . . | . . . | . . . |
| | s₀ | No match | No match |
| t₂ | s₉₉₉ | s_{21.020} | h₂ (s₉₉₉) |
| | . . . | . . . | . . . |

In one instance, the system 100 does not need to compute the headings of the non-reference node in the “From the reference node” table (e.g., S₉₉₉ “No match”) or the headings of the reference node in the “Towards the reference node” table (e.g., So “No match”).

In one embodiment, the system 100 can employ “direction” features to remove one or more links that are unidirectional from both tables. For example:
In the “From the reference node” table, if the system 100 determines that the link direction is “Towards,” the system 100 can remove that link and corresponding shape locations in that table.
In the “Towards the reference node” table, if the system 100 determines that the link direction is “From,” the system 100 can remove the link and corresponding shape locations in that table.

In one embodiment, after the system 100 duplicates the shape tables and removes the links that are unidirectional, the system 100 can associate various useful features with each derived shape location including, for example, heading, link ID, driving direction. In one instance, the system 100 can also pair other useful features such as offset and elevation (if needed).

In one embodiment, the system 100 can partition the high-resolution map data by indexing the latitude and longitude. For instance, the system 100 can index (LAT=X.XXXX*, LON=X.XXXX*) in the point-based high-resolution map. By way of example, the system 100 can use the spatial indexing to quickly locate and access the needed data (e.g., stored in or accessible via the geographic database 109) from among a massive or much larger dataset (e.g., the geospatial big data). In comparison, traditional map partitions are often constrained by the maximum distance between two consecutive shape locations so that the bounding box of the partition can be relatively large to collect all candidates.

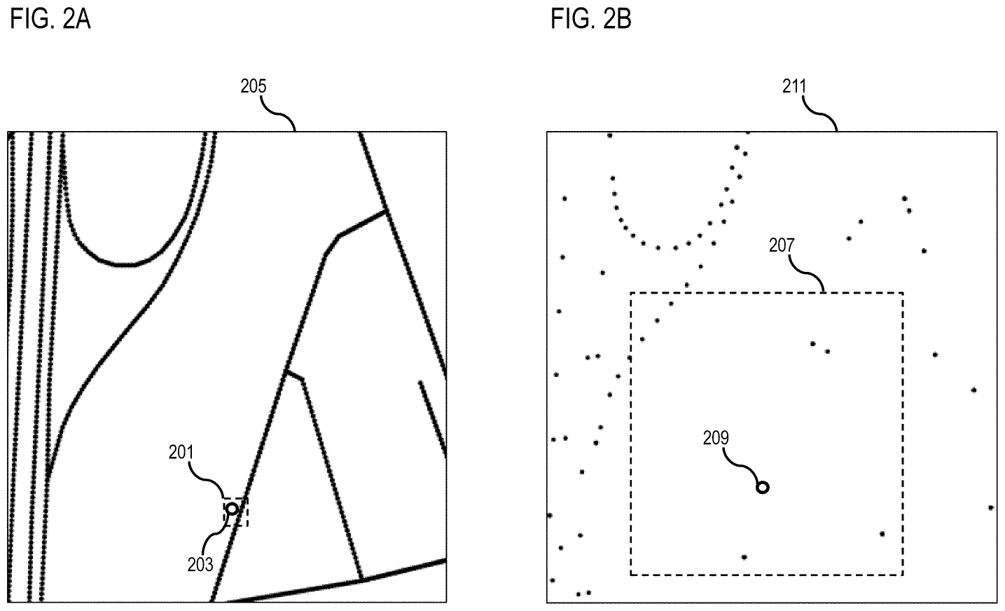

FIGS. 2A and 2B are diagrams of example minimum partition sizes for a high-resolution map (FIG. 2A) and a traditional map (FIG. 2B), respectively, according to example embodiment(s). In one embodiment, the system 100 can determine a significantly smaller minimum partition size 201 to sufficiently process the sensor data 203 (e.g., derived at a point or a location from the vehicles 101, the UEs 115, or a combination thereof) with respect to the high-resolution map 205 of FIG. 2A relative to the minimum partition size 207 required to sufficiently process the sensor data 209 of the traditional map 211 of FIG. 2B. As a result of the smaller partition size (e.g., partition size 201 versus partition size 207), the system 100 can take less time to process geographic big data because each sensor sign in a partition (e.g., sensor sign 203 in partition 201) has much less link/point candidates compared to the sensor sign 209 of the partition 207. As previously mentioned, this time savings can become substantial when the system 100 is processing millions of partitions. In other words, traditional applications (e.g., a navigation application 119) need to associate a sensor/vehicle location (e.g., a sensor 115/vehicle 101) with a known link (line). In contrast, the system 100 can partition the high-resolution map 205 into a relatively smaller scale such that it can convert the application from a point-to-line association to a point-to-point association. As such, the system 100 can use the high-resolution map (e.g., the high-resolution map 205) for fast map-matching and, therefore, it can be suitable for sensor-based map products which need to handle high volumes of GPS-based sensor data (i.e., geographic big data).

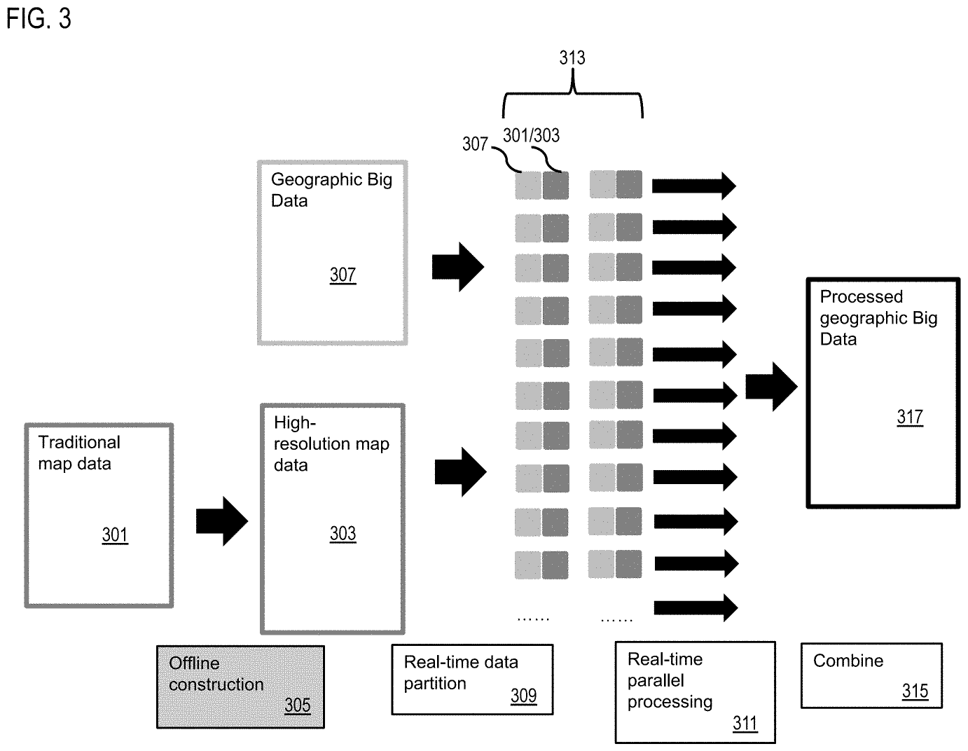

FIG. 3 is an example framework for geographic big data processing using a high-resolution map, according to example embodiment(s). In one embodiment, the system 100 can convert traditional line-based map data to high-resolution point-based map data offline and can process geographic or geospatial big data (e.g., derived from the vehicle sensors 107, the device sensors 117, or a combination thereof) in real time based on the framework built on the generated high-resolution map summarized and depicted in FIG. 3 as follows:
First, in one embodiment, the system 100 can convert the traditional line-based map data 301 to the high-resolution map data 303 offline during an offline construction process 305.
Second, in one embodiment, the system 100 update the high-resolution map data 303 during the offline construction process 305 each time the traditional map data 301 is updated (e.g., during a quarterly update). In one instance, as described above, the system 100 can partition the high-resolution map data 303 based on the density of the geographic data 307 (e.g., sensor data derived at a point or a location relative to the high-resolution map data 303 from the vehicles 101, the UEs 115, or a combination thereof) during a real-time data partitioning process 309. For example, the geographic data 307 or sensor data in each partition can have less link/point candidates relative to the traditional line-based map data 301.
Last, in one instance, the high-resolution map data 303 can be partitioned by the system 100 (e.g., in real-time) into smaller sizes than the traditional map data 301 during the real-time data partitioning process 309 and thus can be more suitable for the real-time parallel processing process 311. In one instance, the system 100 can process the traditional map data 301, the high-resolution map data 303, and the geographic big data 307 for each partition 313 during the combination process 315 to generate the processed geographic big data 317. As described above with FIG. 2A, the high-resolution map created by the system 100 during the combination process 315 can be created for fast map-matching, thus it is applicable for sensor-based map products which need to handle high volumes of GPS-based sensor data (e.g., the geographic big data 307).

In one instance, the framework of FIG. 3 can enable the system 100 to extract roadwork links, for example, significantly faster using the generated high-resolution map 301 compared to a traditional route builder (e.g., using the traditional map data 305). For example, using a single central processing unit (CPU) of 2.6 gigahertz (GHz), the system 100 can construct routes using 1,160,000 roadwork trajectories as follows:
Traditional single point-based map-matching can take approximately 1 hour to map-match 15,000-50,000 locations and the total processing time may amount to up to around 40 hours.
In contrast, in one embodiment, the system 100 using the high-resolution map framework of FIG. 3 can take approximately 1 hour to map-match 150,000-200,000 locations with a total processing time of just around 6.5 hours.
   In addition, in one embodiment, the system 100 can map-match data observations (e.g., derived from the vehicles 101, the UEs 115, or a combination thereof) using the high-resolution point-based map with the same or similar results as previously achieved with a traditional map.

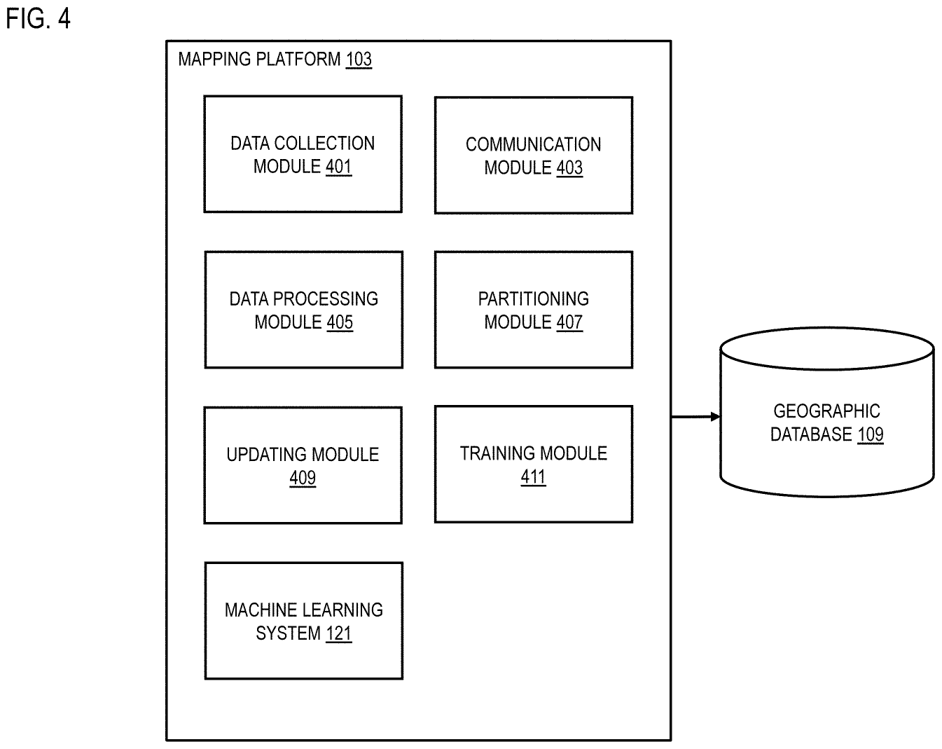

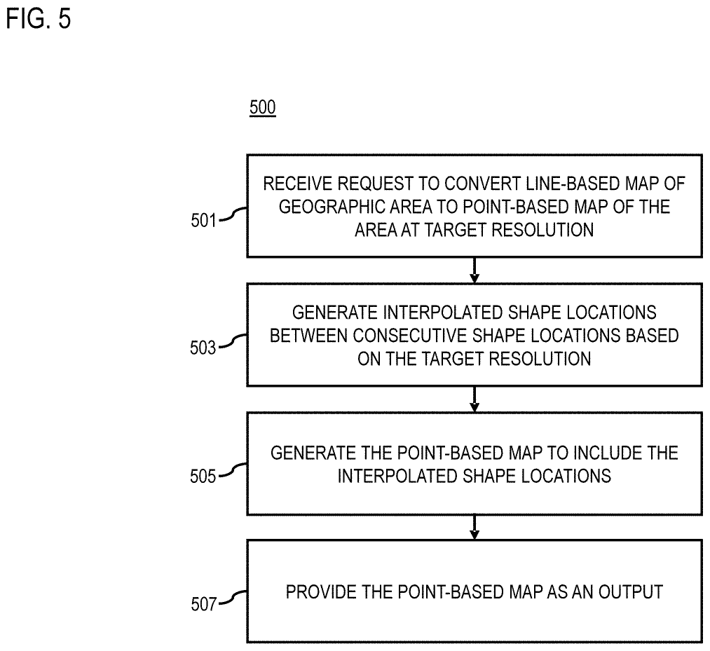

FIG. 4 is a diagram of the components of the mapping platform 103, according to example embodiment(s). By way of example, the mapping platform 103 includes one or more components capable of generating a high-resolution map for geospatial big data processing, according to the example embodiment(s) described herein. It is contemplated that the functions of these components may be combined or performed by other components of equivalent functionality. In one embodiment, the mapping platform 103 includes a data collection module 401, a communication module 403, a data processing module 405, a partitioning module 407, an updating module 409, a training module 411, and the machine learning system 121, and has connectivity to the geographic database 109. The above presented modules and components of the mapping platform 103 can be implemented in hardware, firmware, software, or a combination thereof. Though depicted as a separate entity in FIG. 1, it is contemplated that the mapping platform 103 may be implemented as a module of any other component of the system 100. In another embodiment, the mapping platform 103, the machine learning system 121, and/or the modules 401-411 may be implemented as a cloud-based service, local service, native application, or combination thereof. The functions of the mapping platform 103, the machine learning system 121, and/or the modules 401-411 are discussed with respect to FIG. 5.

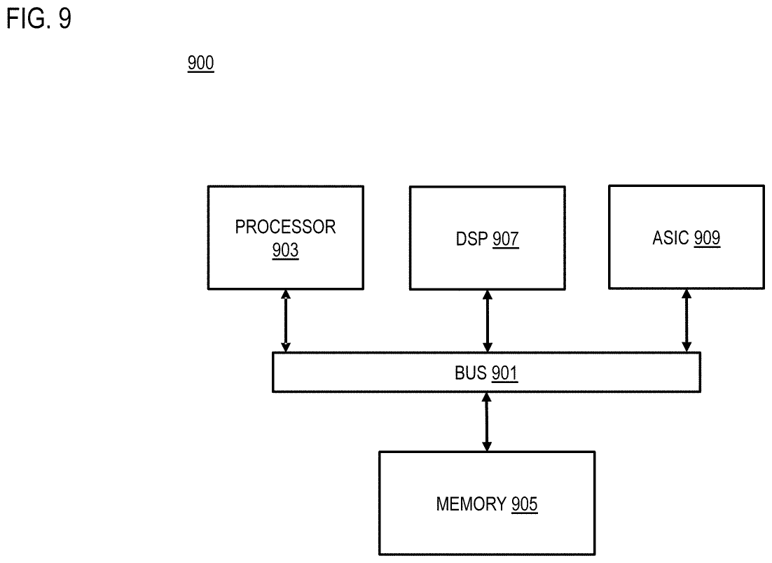

FIG. 5 is a flowchart of a process 500 for generating a high-resolution map for geospatial big data processing, according to example embodiment(s). In various embodiments, the mapping platform 103, the machine learning system 121, and/or any of the modules 401-411 may perform one or more portions of the process 500 and may be implemented in, for instance, a chip set including a processor and a memory as shown in FIG. 9. As such, the mapping platform 103, the machine learning system 121, and/or the modules 401-411 can provide means for accomplishing various parts of the process 500, as well as means for accomplishing embodiments of other processes described herein in conjunction with other components of the system 100. Although the process 500 is illustrated and described as a sequence of steps, its contemplated that various embodiments of the process 500 may be performed in any order or combination and need not include all the illustrated steps.

In step 501, the data collection module 401 and/or the communication module 403 can receive a request to convert a line-based map representation of a geographic area to a point-based map representation of the geographic area at a target resolution, wherein the line-based map representation of the geographic area represents one or more map features in the geographic area as a plurality of links respectively formed by at least two shape locations. In one instance, the data collection module 401 and/or the communication module 403 can receive the request via the vehicles 101 (e.g., an autonomous vehicle), the UEs 115 (e.g., a mobile device), the applications 119 (e.g., a navigation application, a mapping application, etc.), or a combination thereof.

In one instance, the line-based map representation can be a traditional map (e.g., a digital map 113) including one or more traditional map features. In contrast, a point-based map representation is a map representation of a geographic area at a much higher resolution. For example, the data size of the point-based map (i.e., a high-resolution map) preserves not only all the traditional map features but also sufficient point-based features for geographic big data processing. In one instance, the target resolution is higher than a resolution of the at least two shape locations. In one embodiment, the one or more map features can be a road or link (e.g., the link 111) and the target resolution can be based on a lane width of the road (e.g., 3 m). By way of example, the target resolution of a lane width is important because that level of precision is sufficient for most transportation applications (e.g., a standard navigation application 119) and often the minimum resolution required for many advanced transportation applications (e.g., a navigation application 119 for an autonomous or semi-autonomous vehicle 101).

In step 503, the data processing module 405 can generate one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location. In other words, the data processing module 405 can set the resolution of each link segment. In one instance, the interpolating by the data processing module 405 is linear and even so that each interpolated segment has the same length and heading.

The generating of the one or more interpolated shape locations by the data processing module 405 is important, for example, because it can generate new data and/or sufficient point-based features for geographic and/or geospatial big data processing. Moreover, the generating of the one or more interpolated shape locations between consecutive shape locations (e.g., of the line-based map) by the data processing module 405 can generate new and/or additional data for processing the geospatial big data without destroying or deleting the existing map features of the line-based map representation.

In one embodiment, the partitioning module 407 can partition the point-based map representation into one or more partitions based on a partition distance less than a maximum distance between the at least two consecutive shape points of the plurality of links, wherein the one or more interpolated shape locations are further based on the one or more partitions. In one instance, the partitioning module 407 can assign a sequence ID (e.g., i+0.001 to i+0.001*N) so that each link segment formed by two nearby shape locations has a unique partition number and resolution. By way of example, using the target resolution and/or the partition distance (e.g., a lane width, 3 meters, etc.), the partitioning module 407 can calculate the number of partitions and the data processing module 405 can interpolate each link segment formed by two consecutive shape locations accordingly.

In step 505, the data processing module 405 can generate the point-based map representation to include the one or more interpolated shape locations. In one instance, the point-based map representation further includes one or more nodes associated with the plurality of links, the at least two shape locations, or a combination thereof. For example, if the data processing module 405 determines that the new sequence (e.g., sᵢ+0.001 to sᵢ+0.001*N) is equal to 0, the data processing module 405 can determine that the corresponding shape location is the reference node of the that link. Alternatively, if the data processing module 405 determines that the new sequence is equal to 999, the data processing module 405 can determine that the corresponding shape location is the non-reference node of that link. In one instance, the plurality of links respectively includes a reference node, and wherein the link heading associated with the one or more interpolated shape locations is determined by the data processing module 405 in a first direction from the reference node (e.g., “From the reference node”), in a second direction towards the reference node (e.g., “Towards the reference node”), a combination thereof (e.g., “Both”). In one embodiment, the one or more interpolated shape locations are further associated with link identifier information, driving direction information, link offset information, elevation information (if needed), or a combination thereof by the data processing module 405 and/or the data collection module 401. By way of example, the link identifier information, driving direction information, link offset information, elevation information, or a combination thereof may be stored in or accessible via the geographic database 109.

In step 507, the communication module 403 can provide the point-based representation as an output. In one instance, the communication module 403 can provide the output via a user interface (UI) (e.g., an application 119) of a UE 115 (e.g., a mobile device, a smartphone, a terminal, etc.). In one instance, the output (e.g., a point-based map representation of the given geographic area) can be provided by the communication module 403 to a location-based service provider (e.g., a navigation or mapping service provider), a data consumer (e.g., a municipality interested in traffic optimization, a software developer, etc.), a data producer (e.g., vehicles 101, drivers, etc.), or a combination thereof.

In one embodiment, the partitioning module 407 can partition the output (e.g., a point-based map representation) into one or more partitions based on an indexing of geographic coordinates. By way of example, the partitioning module 407 can partition the map data by indexing the latitude and longitude. For instance, the partitioning module 407 can index (LAT=x.xxxx*, LON=x.xxxx*) in the generated point-based map representation.

In one embodiment, the data processing module 405 can initiate a processing of the geographic data associated with the geographic area based on the one or more partitions. In one embodiment, the geographic data can comprise a sensor location, a vehicle location, a point, or a combination thereof (e.g., GPS-based sensor data derived at a point or a location relative to the point-based map representation from the vehicle sensor 107, the device sensors 117, or a combination thereof). In one instance, the processing of the geographic data comprises associating the sensor data, the vehicle 101 location, the point, or a combination thereof with a point of the point-based representation (e.g., as compared to a point-to-line association). In one embodiment, the data processing module 405 can process the geographic data in real time. By way of example, the partitioning of the point-based map representation based on the indexing is important, for example, because as described above, the one or more corresponding partitions generated by the partitioning module 407 can be significantly smaller than the partitions generated from a line-based map representation, which can enable the data processing module 405 to process geographic and/or geospatial big data in relatively less time (e.g., quickly map-match high volumes of GPS-based sensor data) compared to using the line-based map representation alone for such purposes. Moreover, the relative time savings can be significantly increased when the data processing module 405 processes millions of partitions (e.g., in connection with a large-scale digital map update).

The partitioning of the point-based map representation by the partitioning module 407 is also important, for example, because the partitioning into a smaller size than the traditional map enables the processing by the data processing module 405, in one embodiment, to comprise parallel processing. For example, due to the small data size, each partition can process more geographic data and can be more suitable, for example, for big data processing.

In one embodiment, the data processing module 405 can convert the line-based map representation to the point-based map representation in an offline mode. The conversion of the line-based map representation by the data processing module 405 in an offline mode is important because the offline construction can save computing resources (e.g., cloud computing services) and, therefore, minimize costs. In one instance, the partitioning of the point-based map representation by the partitioning module 407 in the offline mode can be based, for example, on a density of the geographic data in the geographic area. For example, the sensor data (e.g., derived from the vehicle sensors 107, device sensors 117, or a combination thereof) in each partition can have less link/point candidates than that in the traditional line-based map representation of the given geographic area. In one instance, the updating module 409 can update the point-based map representation based on an update to the line-based representation. By way of example, the updating module 409 can update the point-based map offline each time the line-based map has a quarterly update.

In one embodiment, the training module 411 and the machine learning system 121 can select and/or tune the target resolution (e.g., the resolution of each link segment: r(sᵢ)) and the respective weights or weighting schemes used by the data processing module 405 to generate the one or more interpolated shape locations between the at least two consecutive shape locations of the at least two shape locations. In one instance, the training module 411 can train the machine learning system 121 with respect to generating the duplicate shape location tables: one to compute the heading from the reference node and the other to compute the heading towards the reference node and to remove links form the tables that are unidirectional. In one instance, the training module 411 can continuously provide and/or update a machine learning module (e.g., a support vector machine (SVM), neural network, decision tree, etc.) of the machine learning system 121 during training using, for instance, supervised deep convolution network or equivalents. By way of example, the training module 411 can train the machine learning module using the respective desired or required target resolution to tune the generation of the point-based map representation, the partitioning of the point-based map representation, or a combination thereof based on an amount of required time and/or a resulting accuracy of the provided point-based map representation output. In one instance, the training module 411 can also train the machine learning module to map-match the one or more interpolated shape locations (e.g., using ground truth data stored in or accessible via the geographic database 109).

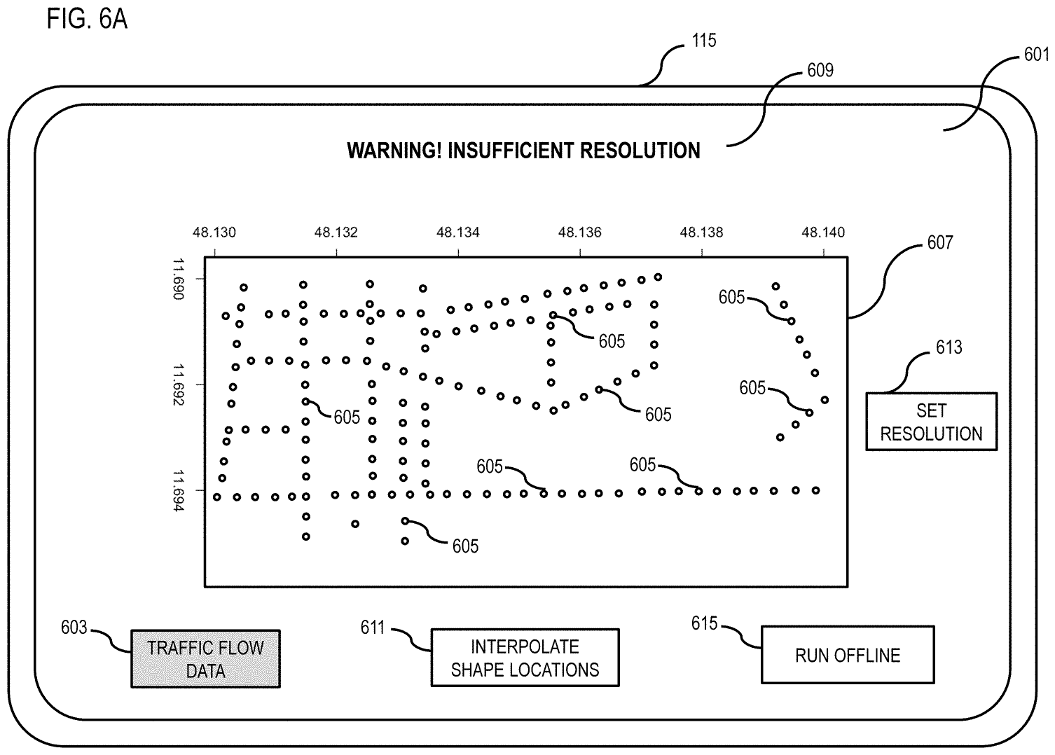

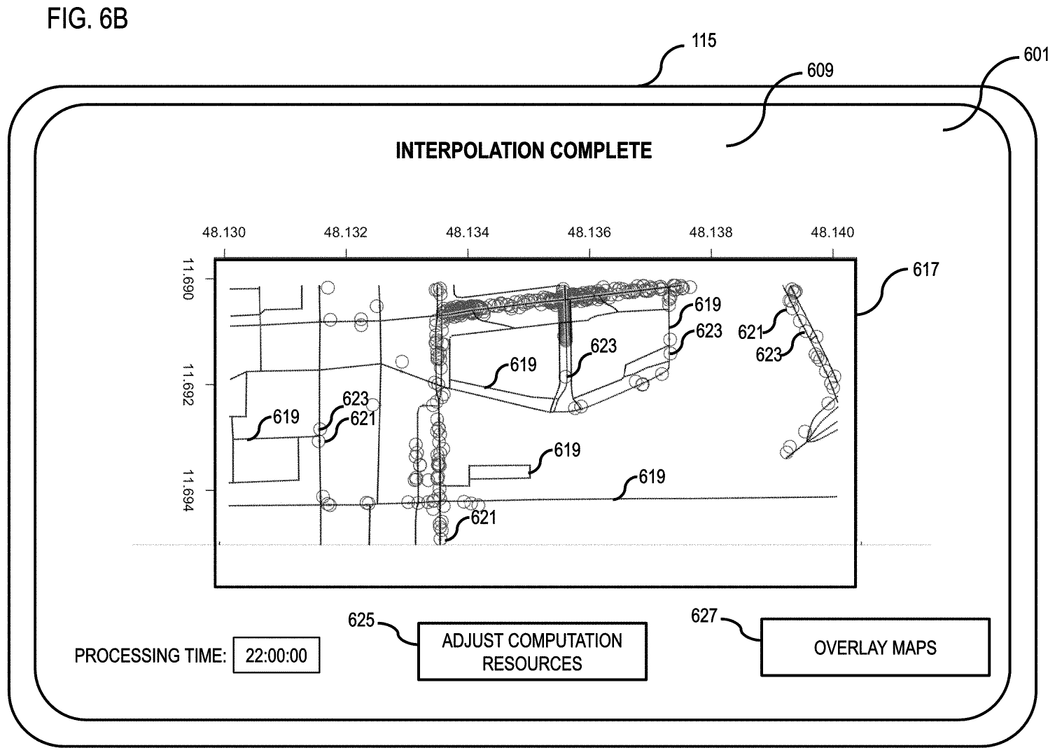

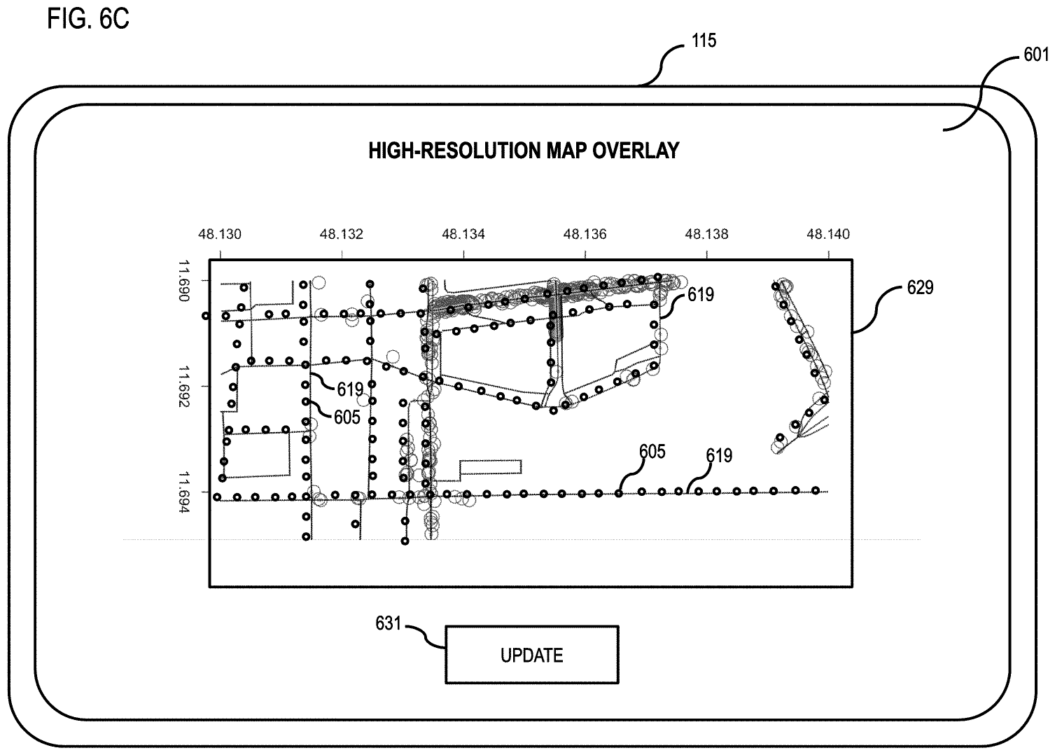

FIGS. 6A through 6C are diagrams of example user interfaces capable of generating a high-resolution map for geospatial big data processing, according to example embodiment(s). In one example use case, a user (e.g., a city planner, a municipality, a traffic specialist, etc.) may want to quickly map match a large set of sensor or probe data (e.g., geographic data and/or geospatial big data) recently collected from the vehicles 101, the UEs 115, or a combination thereof traveling and/or having traveled in an area to determine the best time to start a roadwork project in that area to minimize any interruptions of the traffic flow. In another example use case, the user may want to quickly map match geospatial big data ahead of a zoning or planning meeting. In yet another example use case, a user (e.g., a software programmer) may want to process geospatial big data quickly and accurately while minimizing costs to check that a developed application 119 (e.g., a navigation or mapping application for autonomous vehicles 101) is working properly and/or within a sufficient error tolerance to ensure the safety of the vehicles 101 and/or nearby people and property.

In one embodiment, the system 100 can generate a UI 601 (e.g., a mapping application 119) for a UE 115 (e.g., a mobile device, a smartphone, a terminal, etc.) that can enable a user (e.g., a software developer) to generate a high-resolution map for geospatial big data processing (e.g., map matching). Referring to FIG. 6A, in one embodiment, the system 100 can generate the UI 601 such that it includes an input 603 (e.g., “Traffic Flow Data”) to enable the user to cause the system 100 to collect or to receive sensor data related to the traffic flow patterns for a given area (e.g., as depicted by the shaded input 603). In one instance, as described above, the system 100 can collect or receive data directly from the nearby past or present (e.g., real-time) vehicles 101, the UEs 115, or a combination thereof and/or from data or information stored in or accessible via the geographic database 109. In one instance, the system 100 can generate the input 603 such that a user can change or specify the desired application so that the UI 601 can also be used by the user to analyze and/or to generate a high-resolution map for geospatial big data processing in connection with similar or additional analysis (e.g., related to roadwork, traffic signs, etc.).

In one embodiment, the system 100 can determine that the collected or received data (e.g., stored in or accessible via the geographic database 109) and/or the resolution of the links and shape locations for the given area as depicted by the shape locations 605 of the digital map 607 is not sufficient for safe vehicle 101 travel, particularly autonomous vehicle 101 travel that requires at least lane-level resolution (e.g., 3 m) or better. For example, the system 100 can determine that the shape locations 605 and corresponding resolution may be more consistent with a traditional map resolution (e.g., as described with respect to FIG. 2B) whereas a high-resolution point-based map resolution (e.g., as described with respect to FIG. 2A) is required for the current application (e.g., real-time traffic flow pattern analysis). In one instance, the system 100 can generate a warning or a notification 609 via the UI 601 (e.g., “Warning! Insufficient Resolution”) to alert the user of the potential safety hazard.

In one embodiment, the system 100 can generate the UI 601 such that it includes an input 611 (e.g., “Interpolate Shape Locations”), which the user can interact with to cause the system 100 to calculate the number of partitions and to interpolate each link segment formed between two nearby shape locations using the desired resolution (e.g., 3 m). In one instance, the system 100 can interpolate the shape locations as depicted in FIG. 6B in a liner and even manner so that each interpolated segment has the same length and heading. In one instance, the system 100 can generate the UI 601 such that it includes an input 613 (e.g., “Set Resolution”), which the user can interact with to set (e.g., input and/or increase/decrease) the specific resolution used by the system 100 to calculate the partitions and interpolate the new shape locations according to the various embodiments described herein. For example, a software programmer may want to incrementally adjust with the resolution to understand how such changes may affect the application 119's processing time/cost ratio.

In one instance, the system 100 can generate the UI 601 such that it includes an input 615 (e.g., “Run Offline”) so that the user can chose to convert the line-based map 607 into a high-resolution point-based map (e.g., as depicted in FIG. 6B) in an offline mode of the UE 115 (e.g., a mobile device). For example, the user may want to use the UE 115 offline to minimize one or more computational costs (e.g., cloud computing resources), while a user is in an area with minimal network connectivity (e.g., via the communication network 105), during a time of potential network interference, etc. As mentioned, the ability of the system 100 to construct the high-resolution point-based map offline can save a user in terms of time and computation resource costs and can reduce the system 100's the chances of duplicate computing during the real-time geographic big data processing, further saving a user time and cost.

In one instance, a user interaction with one or more inputs of the UI 601 (e.g., inputs 603, 611, 613, 615, etc.) can include one or more physical interactions (e.g., a touch, a tap, a gesture, typing, etc.), one or more voice commands, or a combination thereof. In one instance, the system 100 can generate the UI 601 such that it can provide a user with one or more audio cues or audible feedback in response to one or more user interactions with the UI 601. In one embodiment, the system 100 can generate all the inputs described with respect to FIGS. 6A and 6B such that they all have the same functionality in terms of user interaction/operability.

Referring to FIG. 6B, in one embodiment, the system 100 can generate the UI 601 such that it can render the high-resolution point-based map 617 generated by the system 100 according to the various embodiments described herein including the high-resolution shape locations 619 (e.g., the black points), vehicle trajectories 621 (e.g., the circles), and matched shape locations 623 (e.g., the grey points). In one instance, the system 100 can generate the UI 601 such that it can provide the user with the amount of time that was required to process all the geographic data (e.g., less than 24 hours to process 30-40 million vehicle traces). In one embodiment, the system 100 can generate the UI 601 such that it includes an input 625 (e.g., “Adjust Computation Resources”) to enable the user to adjust or to set the number of computing nodes/threads used for the geographic data processing. Further, in one instance, the system 100 can also generate the UI 601 such that it includes an input 627 (e.g., “Overlay Maps”) to enable the user to view the high-resolution point-based map 617 overlaid upon the traditional line-based map 607 (e.g., for accuracy analysis purposes) since the data size of the new high-resolution map 617 preserves not only all the traditional map features but also sufficient point-based features to process big data, as depicted in FIG. 6C.

Referring to FIG. 6C (e.g., “High-Resolution Map Overlay”), in response to a user interaction with the input 627 as described above (e.g., a touch), the system 100 can generate the UI 601 such that it includes the map 629 consisting of the high-resolution point-based map 617 overlaid upon the traditional line-based map 607. For example, the system 100 and/or the user can use the overlay to check the accuracy of the interpolation of shape locations by the system 100. In this example UI 601, one can graphically or visually observe, for example, how the system 100 interpolates the high-resolution shape locations 619 between the traditional shape locations 605. In one embodiment, the system 100 can generate the UI 601 such that it includes an input 631 (e.g., “Update”) to enable a user to check for updates with respect to the traditional map 607 (e.g., where the overlay of maps 607 and 617 is off by a threshold amount or percentage). For example, as described above, the system 100 can update the high-solution point-based map 617 offline each time the traditional map 607 has a quarterly update.

Returning to FIG. 1, in one embodiment, the vehicles 101 can be standard vehicles (e.g., a car), autonomous vehicles, HAD vehicles, semi-autonomous vehicles, etc. Although the vehicles 101 are depicted as automobiles, it is contemplated that the vehicles 101 can be any type of private, public, or shared manned or unmanned vehicle (e.g., cars, trucks, buses, vans, motorcycles, scooters, bicycles, drones, etc.) that can traverse one or more links of a given area (e.g., the link 111 of the digital map 113).

In one embodiment, as previously stated, the vehicles 101 can be configured with one or more vehicle sensors 107 for generating or collecting probe data, sensor data, geographic data, map data (e.g., traffic data), geospatial big data, etc. In one embodiment, the sensor data may be associated with a geographic location or coordinates at which the sensor 107 data was collected (e.g., a latitude and longitude pair). As mentioned, in one instance, the system 100 can partition the map data by indexing the latitude and longitude. In one embodiment, the probe data (e.g., stored in or accessible via the geographic database 109) includes location probes collected by one or more vehicles 101, a UE 115 associated with a vehicle 101, or a combination thereof. By way of example, the vehicle sensors 107 may include a RADAR system, a LiDAR system, GPS sensors for gathering location data, a network detection sensor for detecting wireless signals or receivers for different short-range communications (e.g., Bluetooth, Wi-Fi, Li-Fi, NFC, etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged (e.g., driving lights on), and the like. In other words, all this data may comprise the geospatial big data processed by the system 100.

Other examples of vehicle sensors 107 may include light sensors, orientation sensors augmented with height sensors and acceleration sensors (e.g., an accelerometer can measure acceleration and can be used to determine orientation of the vehicle), tilt sensors to detect the degree of incline or decline of a vehicle 101 along a path of travel, moisture sensors, pressure sensors, etc. In a further example embodiment, vehicle sensors 107 about the perimeter of a vehicle 101 may detect the relative distance of the vehicle 101 from a physical divider, a lane line of a link or roadway, the presence of other vehicles, pedestrians, traffic lights, potholes, road signs or markers, and any other objects, or a combination thereof. In one scenario, the vehicle sensors 107 may detect contextually available information such as weather data, traffic information, or a combination thereof. In one embodiment, a vehicle 101 may include GPS or other satellite-based receivers 107 to obtain geographic coordinates from the satellites 123 for determining a current location and time in relation to a given area (e.g., the area represented by the digital map 113). Further, the location can be determined by visual odometry, triangulation systems such as A-GPS, Cell of Origin, or other location extrapolation technologies.

In one embodiment, the UEs 115 (e.g., a mobile device, a smartphone, a terminal, etc.) can be associated with a user (e.g., an individual) traveling in an area (e.g., the area represented by the digital map 113), a driver or passenger of a vehicle 101, a software programmer or a city planner, or a combination thereof. The UEs 115 can also be associated indirectly (e.g., a mobile device, a smartphone, etc.) or directly (e.g., an embedded navigation system) with a vehicle 101 traveling in an area (e.g., on the link 111 of the digital map 113). By way of example, the UEs 115 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with the vehicles 101 or any combination thereof, including the accessories and peripherals of these devices, or any combination thereof. It is also contemplated that a UE 115 can support any type of interface to the user (such as “wearable” circuitry, etc.). In one embodiment, the vehicles 101 may have cellular or wireless fidelity (Wi-Fi) connection either through the inbuilt communication equipment or from a UE 115 associated with the vehicles 101. Also, the UEs 115 may be configured to access the communication network 105 by way of any known or still developing communication protocols. In one embodiment, the UEs 115 may include the mapping platform 103 to generate a high-resolution map for geospatial big data processing.

In one embodiment, the UEs 115 can include device sensors 117 (e.g., GPS sensors, location sensors, a front facing camera, a rear facing camera, LiDAR sensors, sound sensors, height sensors, tilt sensors, moisture sensors, pressure sensors, wireless network sensors, etc.) and applications 119 (e.g., mapping applications, navigation applications, map-matching applications, real-time traffic monitoring applications, data processing and/or updating applications, etc.). In one example embodiment, the device sensors 117 (e.g., GPS sensors) can enable the UEs 115 to obtain geographic coordinates from the satellites 123 for determining a current or live location and time. Further, a user or vehicle 101 location within an area (e.g., represented by the digital map 113) may be determined by a triangulation system such as A-GPS, Cell of Origin, or other location extrapolation technologies when cellular or network signals are available (e.g., during the offline processing).

In one embodiment, the mapping platform 103 can perform the process of generating a high-resolution map for geospatial big data processing as discussed with respect to the various embodiments described herein. In one embodiment, the mapping platform 103 can be a standalone server or a component of another device with connectivity to the communication network 105. For example, the component can be part of an edge computing network where remote computing devices (not shown) are installed along or within proximity of one or more links of a given area (e.g., the area represented by the digital map 113).

In one embodiment, the machine learning system 121 of the mapping platform 103 can include a neural network or other machine learning system to tune and/or evaluate one or more algorithms for interpolating location extraction from all link segments, for generating heading derivation from and heading derivation towards reference node shape location tables, for real-time data partitioning and/or real-time parallel processing of geographic big data and/or high-resolution point-based map data, and/or map-matching probe data. In one instance, the machine learning system 121 can select or assign respective weights, correlations, relationships, etc. (e.g., using the training module 411) of the one or more inputs (e.g., stored in or accessible via the geographic database 109) such as links, shape locations, link segments, number of partitions, resolution, trace data sources, etc.

In one embodiment, the machine learning system 121 can iteratively improve the speed and accuracy by which the system 100 can interpolate shape locations, can map-match vehicle 101 trace data based on the generated high-resolution point-based map, etc. In one embodiment, the neural network of the machine learning system 121 is a traditional convolutional neural network which consists of multiple layers of collections of one or more neurons (which are configured to process a portion of an input data). In one embodiment, the machine learning system 121 also has connectivity or access over the communication network 105 to the geographic database 109 that can store one or more labeled or marked features (e.g., link and shape locations of the traditional line-based map, link start and end locations, ground truth data, etc.).

In one embodiment, the mapping platform 103 has connectivity over the communications network 105 to the services platform 125 that provides the services 127a-127n (also collective referred to as services 127). By way of example, the services 127 may include location-based services (e.g., real-time traffic information, fleet management, navigation), ranking and/or evaluation services, data collection services (e.g., probe data, privacy preference data, etc.), mapping services, navigation services, mobility services, autonomous or shared vehicle services, travel planning services, notification services, social networking services, content (e.g., audio, video, images, etc.), application update services, data storage services, contextual information determination services, information-based services (e.g., weather, news, etc.), etc. In one embodiment, the services platform 125 uses the output of the mapping platform 103 (e.g., a high-resolution point-based map, interpolated link locations, or a combination thereof) to provide location-based services such as roadwork analysis, traffic sign analysis, traffic flow pattern analysis, etc.

In one embodiment, the content providers 129a-129n (also collectively referred to as content providers 129) may provide content or probe or sensor data about the vehicles 101, the UEs 115, or a combination thereof traveling or having traveled in a given area (e.g., the area represented by the digital map 113). The content providers 129 may also provide map data and attributes, road and lane attributes, traffic data (e.g., vehicle and pedestrian), parking-related data, event data, POI-based data mobility graphs, historical movement patterns, area population or density models, etc. to the vehicles 101, the mapping platform 103, the geographic database 109, the UEs 115, the applications 119, the machine learning system 121, the services platform 125, and the services 127. The content provided may be any type of content, such as map content (e.g., latitude, longitude, etc.), text-based content (e.g., desired resolution), audio content, video content, image content, etc. In one embodiment, the content providers 129 may provide content regarding the movement of a vehicle 101, a UE 115, or a combination thereof on a digital map or link (e.g., the link 111 of the digital map 113) as well as content that may aid in localizing a user path or trajectory on a digital map or link (e.g., link 111 of the digital map 113) to assist, for example, with determining the location of a vehicle 101, a user, or a combination relative to a link (e.g., the link 111). In one embodiment, the content providers 129 may also store content associated with the vehicles 101, the mapping platform 103, the geographic database 109, the UEs 115, the services platform 125, and/or the services 127. In another embodiment, the content providers 129 may manage access to a central repository of data, and offer a consistent, standard interface to data, such as a repository of the geographic database 109. In one instance, the content providers 129 and the services platform 125 and/or the services 127 can communicate directly.

In one embodiment, a vehicle 101 (e.g., a standard vehicle, an autonomous vehicle, semi-autonomous vehicle, a drone, etc.) and/or a UE 115 (e.g., a mobile device, a smartphone, etc.) may be part of a probe-based system for collecting probe data to calculate a location of a vehicle 101, a UE 115, and/or a UE 115 associated with a vehicle (e.g., an embedded navigation system). In one embodiment, each vehicle 101 and/or UE 115 can be configured to report probe data as probe points, which are individual data records collected at a point in time that records telemetry data for that point in time. In one embodiment, the probe ID can be permanent or valid for a certain period. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 can include the vehicle sensors 107 (e.g., GPS sensors, LiDAR sensors, etc.) for reporting measuring and/or reporting attributes. The attributes can also be any attribute normally collected by an on-board diagnostic (OBD) system of the vehicles 101, and available through an interface to the OBD system (e.g., OBD II interface or other similar interface).

In one embodiment, the probe points can be reported from the vehicles 101 and/or the UEs 115 in real-time, in batches, continuously, or at any other frequency requested by the system 100 over the communication network 105 for processing by the mapping platform 103. In one instance, the system 100 can preprocess and can update the high-resolution map offline each time that the base map (e.g., the traditional map) has a quarterly update.

In one embodiment, the UEs 115 may also be configured with various sensors (e.g., device sensors 117) for acquiring and/or generating probe data and/or sensor data associated with a user and/or a vehicle 101 (e.g., a driver or a passenger). For example, the device sensors 117 may be used as GPS receivers for interacting with the one or more satellites 123 to determine a shape location heading, start or end nodes of a link, shape locations in an area (e.g., represented by the digital map 113), etc. In addition, the device sensors 117 can gather driving direction, elevation, offset, tilt data (e.g., a degree of incline or decline of a vehicle 101 during travel), motion data, light data, sound data, image data, weather data, temporal data, and other data associated with the vehicles 101 and/or the UEs 115. Still further, the device sensors 117 may detect a local or transient network and/or wireless signals such as those transmitted by nearby devices (e.g., UEs 115) during navigation along a roadway (Li-Fi, NFC), etc.

It is noted therefore that the above-described data may be transmitted via the communication network 105 as probe data according to any known wireless communication protocols. For example, each user, vehicle 101, UE 115, and/or application 119 may be assigned a unique probe identifier (probe ID) for use in reporting or transmitting said probe data collected by the vehicles 101 and/or the UEs 115. In one embodiment, each vehicle 101 and/or UE 115 is configured to report probe data as probe points, which are individual data records collected at a point in time that records telemetry data.

In one embodiment, the mapping platform 103 can retrieve aggregated probe points (e.g., probe trajectories, vehicle trace data, etc.) gathered and/or generated by the vehicle sensors 107 and/or the device sensors 117 at specific times resulting from the travel of the vehicles 101 and/or the UEs 115 on a road segment of a road network of a digital map space (e.g., the link 111 of the digital map 113). In one instance, the geographic database 109 stores a plurality of probe points and/or trajectories (e.g., vehicle traces) generated by different vehicles 101, vehicle sensors 107, UEs 115, device sensors 117, applications 119, etc. over time. A time sequence of probe points specifies a trajectory—i.e., a path traversed by a vehicle 101, a UE 115, or a combination thereof over that time.

In one embodiment, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for 5G New Radio (5G NR or simply 5G), microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 103 may be a platform with multiple interconnected components. The mapping platform 103 may include multiple servers, intelligent networking devices, computing devices, components, and corresponding software for providing parametric representations of lane lines. In addition, it is noted that the mapping platform 103 may be a separate entity of the system 100, included with a vehicle 101 (e.g., an embedded navigation system), a part of the services platform 125, or a part of the one or more services 127.

In one embodiment, the geographic database 109 can store information or data regarding geographic data, geospatial big data, probe data and/or sensor data. In one instance, the geographic database 109 can store information or data regarding one or more base maps or traditional line-based maps for a given area. The geographic database 109 can store information or data, for example, regarding respective link identifiers, sequence identifiers, driving directions, respective link offsets, relevant elevations (if needed), etc. In one instance, the geographic database 109 can store information or data regarding ground truth data, respective weights, correlations, and/or relationships of one or more machine learning system 121 inputs such as labeled or marked features (e.g., link and shape locations, link start and end locations, reference nodes, etc.). In one embodiment, the geographic database 109 can be in a cloud and/or in a vehicle 101, a UE 115, or a combination thereof.

By way of example, the vehicles 101, mapping platform 103, vehicle sensors 107, UEs 115, device sensors 117, applications 119, satellites 123, services platform 125, services 127, and/or content providers 129 communicate with each other and other components of the system 100 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

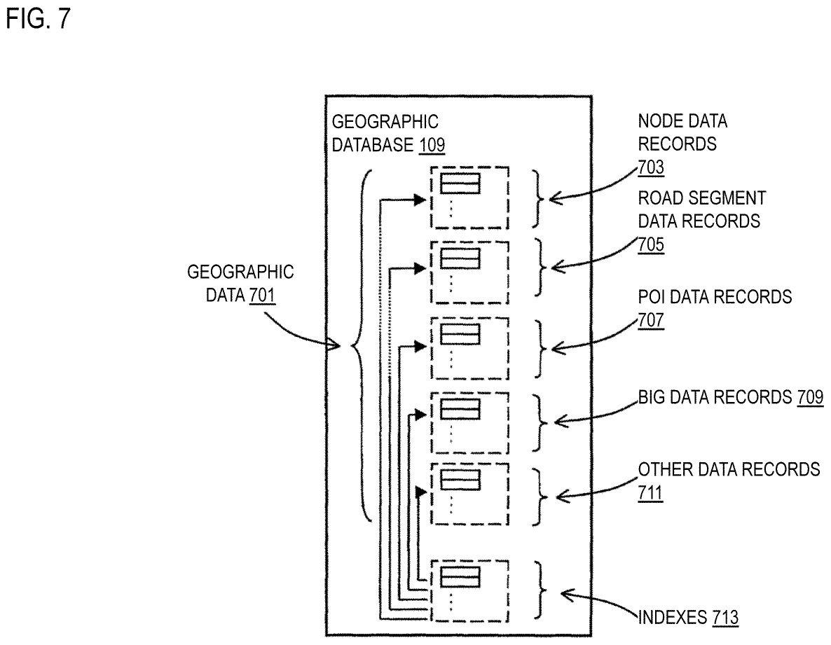

FIG. 7 is a diagram of the geographic database 109, according to example embodiment(s). In one embodiment, the geographic database 109 includes geographic data 701 used for (or configured to be compiled to be used for) generating a high-resolution map for geospatial big data processing. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes (e.g., used to alter a shape of the link without defining new nodes) (i.e., a shape location).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon (e.g., a hexagon) is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node. Also, there are no duplicated shape points, nodes, or links. Two links that connect each other have a common node. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 109 includes node data records 703, road segment or link data records 705, POI data records 707, big data records 709, other records 711, and indexes 713, for example. More, fewer, or different data records can be provided. In one embodiment, additional data records (not shown) can include cartographic (“carto”) data records, routing data, and maneuver data. In one embodiment, the indexes 713 may improve the speed of data retrieval operations in the geographic database 109. In one embodiment, the indexes 713 may be used to quickly locate data without having to search every row in the geographic database 109 every time it is accessed. For example, in one embodiment, the indexes 713 can be a spatial index of the polygon points associated with stored feature polygons.

In exemplary embodiments, the road segment data records 705 are links or segments representing roads, streets, or paths (e.g., link 111 of the digital map 113) that can be used for generating a high-resolution map for geospatial big data processing. The node data records 703 are end points (such as intersections) corresponding to the respective links or segments of the road segment data records 705. In one instance, the link direction can be either “From the reference node,” “Towards the reference node,” and “Both.” In one instance, if the new sequence is equal to 0, the corresponding shape location is the reference node of that link while if it is 999, the corresponding shape location is the non-reference node of that link. The road link data records 705 and the node data records 703 represent a road network, (e.g., link 111) such as used by vehicles 101 and/or other entities. Alternatively, the geographic database 109 can contain path segment and node data records or other data that represent pedestrian paths or areas in addition to or instead of the vehicle road record data, for example.

The road/link segments and nodes can be associated with attributes, such as geographic coordinates (e.g., latitude, longitude, etc.), street names, address ranges, speed limits, turn restrictions at intersections, and other navigation related attributes, as well as POIs, such as a restaurant, a retail shop, an office, etc. The geographic database 109 can include data about the POIs and their respective locations in the POI data records 707. In one embodiment, the POI data records 707 can include population density data, hours of operation, popularity or preference data, prices, ratings, reviews, and various other attributes. The geographic database 109 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a portion of a city).

In one embodiment, the geographic database 109 includes big data records 709. In one instance, the big data records 709 include geographic data, geospatial big data, probe data and/or sensor data for a given area (e.g., the area represented by the digital map 113). In one instance, the big data records 709 can store information or data regarding one or more base maps or traditional line-based maps for a given area. As described above, in one instance, the high-resolution map data is built upon and/or preserves the underlying base map data. In one instance, big data records 709 can store information or data, for example, regarding respective link identifiers, sequence identifiers, driving directions, respective link offsets, elevations (if needed), etc. In one instance, the big data records 709 can store information or data regarding ground truth data, respective weights, correlations, relationships, labeled or marked features (e.g., link and shape locations, link start and end locations, reference nodes, etc.) used in connection with the machine learning system 121, for example. In one embodiment, the map data processing records 709 can be associated with one or more of the node data records 703, road segment or link records 705, and/or POI data records 707; or portions thereof (e.g., smaller or different segments than indicated in the road segment records 705) to enable the system 100 to generate a high-resolution map for geospatial big data processing.

In one embodiment, the geographic database 109 can be maintained by the services platform 125 (e.g., a map developer). The map developer can collect human movement data to generate and enhance the geographic database 109. There can be different ways used by the map developer to collect data. These ways can include obtaining data from other sources, such as municipalities or respective geographic authorities (e.g., services 127, content providers 129, or a combination thereof). In addition, the map developer can employ field personnel to travel by a vehicle 101 along roads throughout an area of interest (e.g., the link 111) to observe and/or record probe trajectory data (e.g., speed, distance, heading, etc.). Similarly, the map developer can employ field personnel to travel by foot throughout an area of interest (e.g., the area represented by the digital map 113) to collect or obtain ground truth data (e.g., a driving direction). Also, remote sensing, such as aerial or satellite photography, can be used.

In one embodiment, the geographic database 109 can include other or additional high resolution or high definition (HD) mapping data that can provide centimeter-level or better accuracy of map features (e.g., for advanced autonomous vehicle 101 navigation). In one instance the HD mapping data can be part of the big data records 709, the geographic or geospatial big data, or it can exist as a separate data set. For example, the geographic database 109 can be based on LiDAR or equivalent technology to collect billions of 3D points and model road surfaces and other map features down to the number lanes and their widths. In one embodiment, the HD mapping data can capture and store details such as the slope and curvature of a road (e.g., the link 111), lane markings, elevation, driving direction, roadside objects such as signposts, including what the signage denotes. By way of example, the other or additional HD mapping data can enable autonomous vehicles 101 to precisely localize themselves on a road or link (e.g., the link 111), and to determine the road attributes (e.g., direction of traffic) at high accuracy levels.

In one embodiment, the geographic database 109 is stored as a hierarchical or multi-level tile-based projection or structure. More specifically, in one embodiment, the geographic database 109 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

The geographic database 109 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101, a vehicle sensor 107, a UE 115, and/or a device sensor 117. The navigation-related functions can correspond to vehicle navigation (e.g., autonomous navigation), pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for generating a high-resolution map for geospatial big data processing may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

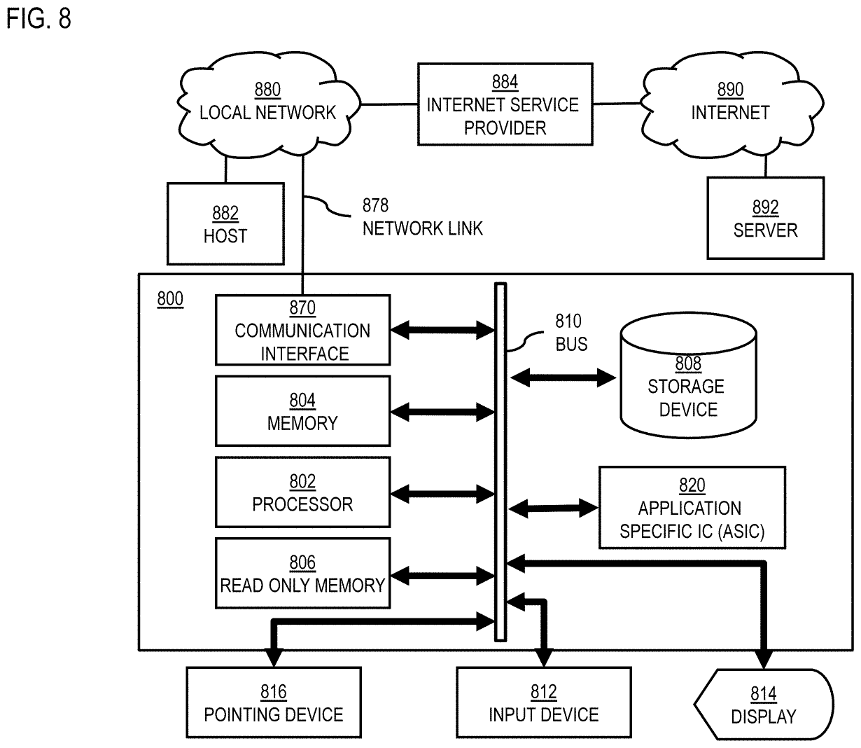

FIG. 8 illustrates a computer system 800 upon which example embodiment(s) of the invention may be implemented. Computer system 800 is programmed (e.g., via computer program code or instructions) to generate a high-resolution map for geospatial big data processing as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to generating a high-resolution map for geospatial big data processing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random-access memory (RAM) or other dynamic storage device, stores information including processor instructions for generating a high-resolution map for geospatial big data processing. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for generating a high-resolution map for geospatial big data processing, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for generating a high-resolution map for geospatial big data processing.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which example embodiment(s) of the invention may be implemented. Chip set 900 is programmed to generate a high-resolution map for geospatial big data processing as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively, or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to generate a high-resolution map for geospatial big data processing. The memory 905 also stores the data associated with or generated by the execution of the inventive steps.

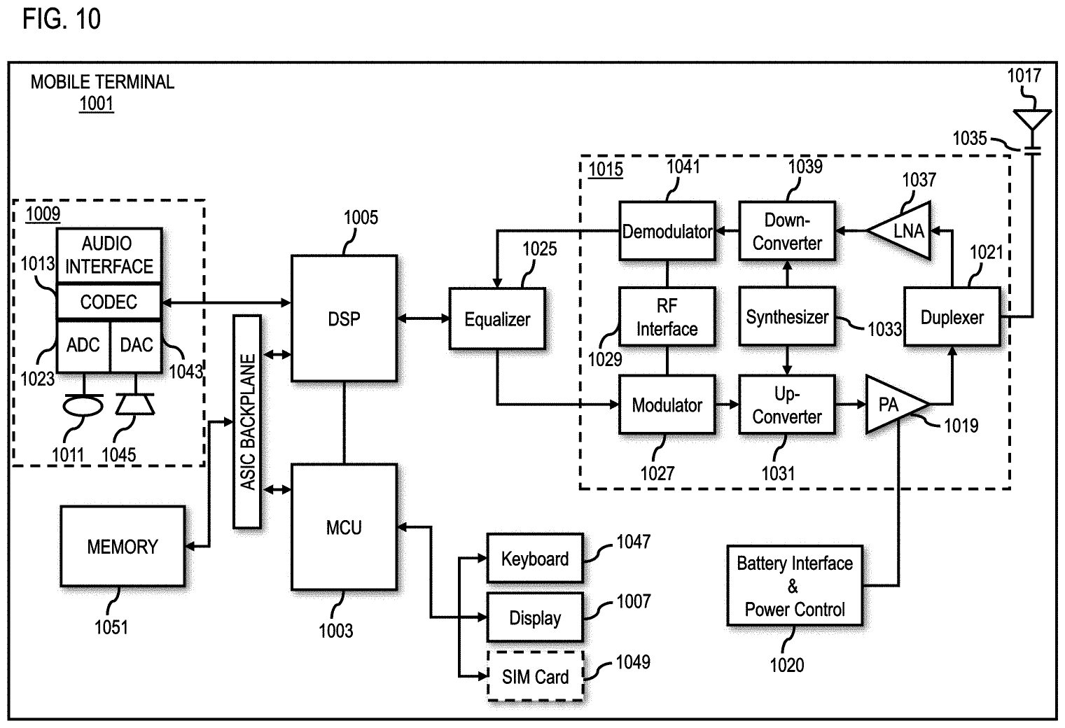

FIG. 10 is a diagram of exemplary components of a mobile terminal 1001 (e.g., a UE 115, a vehicle 101, or a component thereof) capable of operating in the system of FIG. 1, according to example embodiment(s). Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to generate a high-resolution map for geospatial big data processing. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request to convert a line-based map representation of a geographic area to a point-based map representation of the geographic area at a target resolution, wherein the line-based map representation of the geographic area represents one or more map features in the geographic area as a plurality of links respectively formed by at least two shape locations;
generating one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location;
generating the point-based map representation to include the one or more interpolated shape locations; and
providing the point-based map representation as an output.

2. The method of claim 1, wherein the point-based map representation further includes one or more nodes associated with the plurality of links, the at least two shape locations, or a combination thereof.

3. The method of claim 1, wherein the plurality of links respectively includes a reference node, and wherein the link heading associated with the one or more interpolated shape locations is determined in a first direction from the reference node, in a second direction towards the reference node, or a combination thereof.

4. The method of claim 1, wherein the one or more interpolated shape locations are further associated with link identifier information, driving direction information, link offset information, elevation information, or a combination thereof.

5. The method of claim 1, further comprising:
partitioning the point-based map representation into one or more partitions based on a partition distance less than a maximum distance between the at least two consecutive shape points of the plurality of links,
wherein the one or more interpolated shape locations are further based on the one or more partitions.

6. The method of claim 1, further comprising:
partitioning the point-based map representation into one or more partitions based on an indexing of geographic coordinates.

7. The method of claim 6, further comprising:
initiating a processing of geographic data associated with the geographic area based on the one or more partitions.

8. The method of claim 7, wherein the geographic data comprises a sensor location, a vehicle location, a point, or a combination thereof.

9. The method of claim 8, wherein the processing comprises associating the sensor data, the vehicle location, the point, or a combination thereof with a point of the point-based map representation.

10. The method of claim 7, wherein the geographic data is processed in real time.

11. The method of claim 7, wherein the processing comprises a parallel processing.

12. The method of claim 1, wherein the line-based map representation is converted to the point-based map representation in an offline mode.

13. The method of claim 12, wherein the partitioning of the point-based map representation in the offline mode is based on a density of the geographic data in the geographic area.

14. The method of claim 1, further comprising:
updating the point-based map representation based on an update to the line-based representation.

15. An apparatus comprising:
at least one processor; and
at least one memory including computer program code for one or more programs,
the at least one memory and the computer program code configured to, with the at least one processor, cause the apparatus to perform at least the following operations:
receive a request to convert a line-based map representation of a geographic area to a point-based map representation of the geographic area at a target resolution, wherein the line-based map representation of the geographic area represents one or more map features in the geographic area as a plurality of links respectively formed by at least two shape locations;
generate one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location;
generate the point-based map representation to include the one or more interpolated shape locations; and
provide the point-based map representation as an output.

16. The apparatus of claim 15, wherein the point-based map representation further includes one or more nodes associated with the plurality of links, the at least two shape locations, or a combination thereof.

17. The apparatus of claim 15, wherein the plurality of links respectively includes a reference node, and wherein the link heading associated with the one or more interpolated shape locations is determined in a first direction from the reference node, in a second direction towards the reference node, or a combination thereof.

18. The apparatus of claim 15, wherein the apparatus is further caused to:
index the point-based map representation based on geographic coordinates; and
partition the point-based map representation based on the indexing, the geographic coordinates, or a combination thereof,
wherein the one or more partitions are further based on a partition distance less than a maximum distance between the at least two consecutive shape locations of the plurality of links.

19. A non-transitory computer-readable storage medium having stored thereon one or more program instructions which, when executed by one or more processors, cause an apparatus to at least perform the following operations:
receive a request to convert a line-based map representation of a geographic area to a point-based map representation of the geographic area at a target resolution, wherein the line-based map representation of the geographic area represents one or more map features in the geographic area as a plurality of links respectively formed by at least two shape locations;
generate one or more interpolated shape locations between at least two consecutive shape locations of the at least two shape locations based on the target resolution, wherein the one or more interpolated shape locations respectively specify an interpolated point location between the at least two consecutive shape locations and a link heading associated with the interpolated point location;
generate the point-based map representation to include the one or more interpolated shape locations;
process geospatial big data using the point-based map representation to provide roadwork analysis, traffic flow information, geographic map updates, or a combination thereof as an output.

20. The non-transitory computer-readable storage medium of claim 19, wherein the point-based map representation further includes one or more nodes associated with the plurality of links, the at least two shape locations, or a combination thereof.
